(19) United States
(12) Patent Application Publication
(10) Pub. No.: US 2014/0045566 A1
(43) Pub. Date: Feb. 13, 2014

(54) METHOD AND APPARATUS FOR PLAYING A POKER GAME

(71) Applicant: Simon Hewins, Bishops Stortford (GB)

(72) Inventor: Simon Hewins, Bishops Stortford (GB)

(21) Appl. No.: 13/963,280

(22) Filed: Aug. 9, 2013

Related U.S. Application Data
(60) Provisional application No. 61/681,904, filed on Aug. 10, 2012.

(51) Int. Cl. G07F 17/32

(52) U.S. Cl. CPC G07F 17/3293
USPC 463/13

(57) ABSTRACT

In some embodiments, this disclosure relates to a method that includes receiving, at a first time before a second time, an indication of a bet. The bet is associated with first odds of a hand winning and the hand at the first time includes a first card that was dealt from a deck of cards before the first time. The method includes displaying, at the second time before a third time, a payout based on second odds of the hand winning. The hand at the second time includes a second card that was dealt from the deck of cards after the first time but before the second time. The method includes displaying, at a third time after the second time, a player payout portion (1) based on the bet, (2) based on the first odds of the hand winning, and (3) independent of the second odds of the hand winning.

### CROSS-REFERENCE TO RELATED APPLICATION

This application claims priority to and the benefit of U.S. Provisional Application No. 61/681,904 filed on Aug. 10, 2012 and titled “Method and Apparatus for Playing a Poker Game,” the contents of which is herein incorporated by reference in its entirety.

### BACKGROUND

Some embodiments described herein relate generally to a system and method for playing a poker game.

Known systems for playing a poker game exist. For example, Texas Hold' em can use individual player hands, as well as community cards for defining a winning hand. In such known systems, an individual is typically rewarded by receiving a payout equal to an amount of all money bet during a round minus a portion for the house. These known systems, however, do not allow one or more players to hedge their bets throughout the course of a round.

Accordingly, a need exists for an improved system and method for playing a poker game.

### SUMMARY

In one aspect, this disclosure relates to a method that includes receiving, at a first time before a second time, an indication of a bet. The bet is associated with first odds of a hand winning and the hand at the first time includes a first card that was dealt from a deck of cards before the first time. The method includes displaying, at the second time before a third time, a payout based on second odds of the hand winning. The hand at the second time includes a second card that was dealt from the deck of cards after the first time but before the second time. The method includes displaying, at a third time after the second time, a player payout portion (1) based on the bet, (2) based on the first odds of the hand winning, and (3) independent of the second odds of the hand winning.

### BRIEF DESCRIPTION OF THE DRAWINGS

FIG. 1 is a block diagram of a poker game system according to an embodiment.

FIG. 2 is a flow chart showing a method of operating a poker game system according to an embodiment.

FIG. 3 is a flow chart showing a method of operating a poker games system according to an embodiment.

FIG. 4 is an illustration of a poker game system outcome according to an embodiment at a first time.

FIG. 5 is an illustration of the poker game system outcome shown in FIG. 4 at a second time, after the first time.

FIG. 6 is an illustration of the poker game system outcome shown in FIG. 4 at a third time, after the second time.

FIG. 7 is an illustration of the poker game system outcome shown in FIG. 4 at a fourth time, after the third time.

### DETAILED DESCRIPTION

In some embodiments, a method of playing a Player vs. House/Casino card game can include cards being dealt in stages and offering players a chance to bet at each stage on which hand or hands they think will win or draw when all the remaining cards are dealt. The probability of each hand winning or drawing at each stage of the game is dynamically calculated based on the cards dealt and in play at that stage of the game; those probabilities are presented to the players when each stage commences. Players can join the game at any stage and can chose to bet (or not) on any hand or hands. When the game ends the House pays out to all bets on all winning and optionally drawing hands. While embodiments described herein related to the Texas Hold'Em version of Poker, the rules can equally be applied to other forms of poker such as (but not limited to) Omaha and Seven Card Stud.

In some embodiments, this disclosure relates to a method that includes receiving, at a first time before a second time, an indication of a bet. The bet is associated with first odds of a hand winning, and the hand at the first time includes a first card that was dealt from a deck of cards before the first time. The method includes displaying, at the second time before a third time, a payout based on second odds of the hand winning. The hand at the second time includes a second card that was dealt from the deck of cards after the first time but before the second time. The method includes displaying, at a third time after the second time, a player payout portion (1) based on the bet, (2) based on the first odds of the hand winning, and (3) independent of the second odds of the hand winning.

In some embodiments, this disclosure relates to a method that includes receiving, at a first time before a second time, an indication of a first bet. The first bet is associated with a first player and first odds of a hand winning, and the hand at the first time includes a first card that was dealt from a deck of cards before the first time. The method includes receiving, at the second time before a third time, an indication of a second bet. The second bet is associated with a second player and second odds of the hand winning, and the hand at the second time includes a second card that was dealt from the deck of cards after the first time but before the second time. The method includes indicating, at the third time, (1) a player-payout portion associated with the first player and based on the first bet, based on the first odds of the hand winning, and independent of the second odds of the hand winning, and (2) a player-payout portion associated with the second player and based on the second bet, based on the second odds of the hand winning, and independent of the first odds of the hand winning.

In some embodiments, this disclosure relates to a method that includes receiving, at a first time before a second time, an indication of a first bet. The first bet is associated with a player and first odds of a hand winning, and the hand at the first time includes a first card that was dealt from a deck of cards before the first time. The method includes receiving, at the second time before a third time, an indication of a second bet. The second bet is associated with the player and second odds of the hand winning, and the hand at the second time includes a second card that was dealt from the deck of cards after the first time but before the second time. The method includes indicating a player-payout including (1) a first player-payout portion based on the first bet, based on the first odds of the hand winning, and independent of the second odds of the hand winning, and (2) a second player-payout portion based on the second bet, based on the second odds of the hand winning, and independent of the first odds of the hand winning.

As used in this specification, the singular forms “a,” “an” and “the” include plural referents unless the context clearly dictates otherwise. Thus, for example, the term “a deck of cards” is intended to mean a single deck of cards or a combination of decks of cards. Furthermore, as used in this specification, any term referring to a card, deck of cards, or hand (e.g. hand of cards) can refer to a physical card, a representation of a card (e.g. an image of a card on a display, and/or any other indication of a card and/or the strength and/or description of a card). Furthermore, a bet can be a chip, currency, credit, etc, and/or representations of a chip, credit, physical currency. Furthermore, a round can begin when a first card is dealt and can end with a winning hand declared and winnings distributed (and/or losses collected). A hand can be declared the winning hand based on the rules of the underlying poker game. For example, the winning hand in a round of texas hold'em is the highest ranking hand, or hands, defined by a players (or common) hole cards plus any three of the five community cards. In some embodiments, two hands having the same rank can result in a tie.

As is discussed below, a poker game system can be used to play a poker game. The poker game system can be implemented with physical components, for example, a card table, one or more decks of cards, tokens and/or other indicators of a bet and/or a player. In some embodiments, the poker game system can be implemented electronically using program and/or other code using a processor and/or memory, for example, via a video poker machine, local and/or remote computer system, mobile device, etc. In such electronic embodiments, the poker game system can display representations of the components of the system, such as, for example, a card table, one or more decks of cards, tokens and/or other indicators of a bet, and/or one or more living and/or artificial intelligence players. In such embodiments, the processes, methods and/or programs described herein can be a software and/or firmware program embodied in a non-transitory processor-readable medium storing code representing instructions to cause a processor to implement the program.

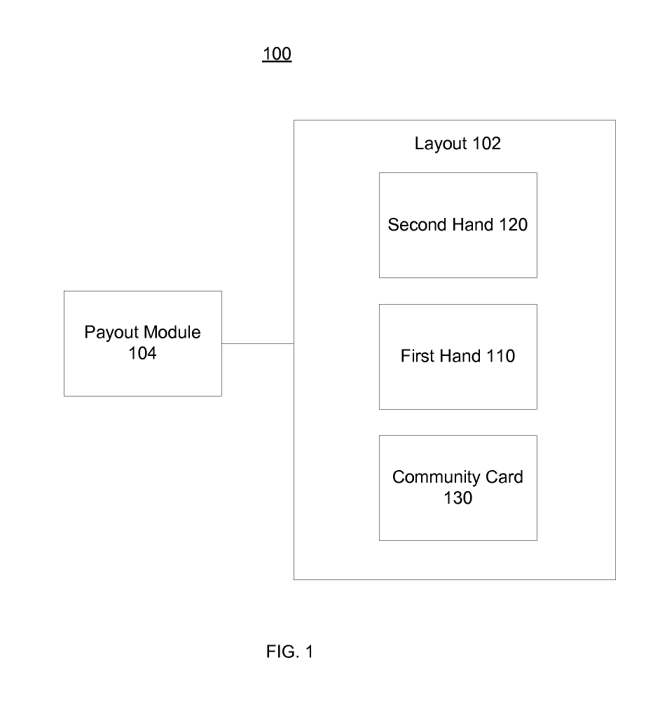

The poker game system can be played with at least one standard 52 card deck (e.g., four suits and two through ace), and the strength of individual cards and/or hands can be in accordance with the standard rules of poker (e.g., Royal Flush beats a Straight Flush beats a Four-of-a-kind, etc). While a portion of the mechanics of the poker game systems described herein can be similar to Texas Hold'em (e.g., number of cards in a hand, number and frequency of community cards, etc), other poker games can be adapted to use the betting mechanics described herein, for example, Omaha Hold'em, etc. In addition to poker games that include community cards, poker games that do not include community cards, such as, for example, draw and/or stud poker can be adapted to use the betting mechanics described herein. Based on the rules of the underlying poker game (e.g., Texas Hold'em), a hand can have mathematical odds of winning (or tying) a round that can change as a round progresses. In some embodiments, a payout, or a payout portion, for a hand winning can be based on the mathematical odds of the hand winning. As described herein, the payout, or payout portion, for a winning hand can be based on other odds, e.g. margin odd and/or rounded odds. As used in this specification, “odds” can refer to mathematical odds, margin odds, and/or rounded odds. FIG. 1 depicts a block diagram of a poker game system (“system”) 100. System 100 includes a layout 102 and a payout module 104. Layout 102 includes a first hand 110, a second hand 120 and a community card 130.

First hand 110 can include two cards dealt from a deck of cards (not shown). Similarly, second hand 120 can include two cards dealt from the deck of cards. First hand 110 can have first odds associated with winning (e.g. mathematical odds of first hand 110 beating second hand 120 based on, for example, cards currently dealt and cards remaining in the deck), and an associated payout based on those odds, after first hand 110 and second hand 120 are dealt, but before community card 130 is dealt (a first time). In such embodiments, an associated payout can be defined by payout module 104 described below. Similarly, second hand 120 can have first odds associated with winning (e.g. mathematical odds of second hand 120 beating first hand 110, based on, for example, cards currently dealt and cards remaining in the deck), and an associated payout based on those odds, after the first hand 110 and the second hand 120 are dealt, but before community card 130 is dealt. A first player and/or a second player can place a bet on first hand 110 and/or second hand 120 at the first time. In some embodiments, a bet made on a future winning hand at the first time can result in a first portion of winnings based on the odds of that hand winning at the first time. For example, if first hand 110 is declared the winner after a round is over and the first player placed a $10 bet on first hand 110 at the first time with 10:1 payout, the first player would receive a first portion of winnings of $100, regardless of the odds of winning at any other time.

Community card 130 can include between one and five additional cards dealt from the deck of cards at one or more times after the first time. The system 100 can combine one or more community cards 130 with first hand 110 and/or second hand 120 to define the strongest possible hand. In some embodiments a first community card 130, a second community card (not shown), and a third community card (not shown) (collectively the “flop cards”), can be dealt substantially simultaneously at a second time, after the first time. In such embodiments, first hand 110 can have second odds associated with winning, and an associated payout based on those odds, at the second time. Similarly, second hand 120 can have second odds associated with winning, and an associated payout based on those odds, at the second time. The first player and/or the second player can place a bet on first hand 110 and/or second hand 120 at the second time. In some embodiments, a bet made on a future winning hand at the second time can result in a first portion and/or a second portion of winnings based on the odds of that hand winning at the second time.

With continued reference to the previous example, both the first player and the second player can place a $20 bet on first hand 110 at the second time with 2:1 payout. If after a round is over and first hand 110 is declared the winner, the first player would receive a second portion of winnings of $40 and the second player would receive a first portion of winnings of $40, regardless of the odds of winning at any other time. In such an example, the total winnings would be $140 to the first player ($100 first portion of winnings from the first time and $40 second portion of winnings from the second time) and $40 to the second player ($40 first portion of winnings from the second time).

In some embodiments, a fourth community card 130 (“turn card”) can be dealt at a third time, after the second time. After the turn card is dealt, the odds of winning, and associated payouts based on those odds, for first hand 110 and second hand 120, can change again. One or more players can place a bet on first hand 110 and/or second hand 120 at the third time. In some embodiments, a bet made on a future winning hand at the third time can result in a first portion and/or a second portion and/or a third portion of winnings based on the odds of that hand winning at the third time, regardless of the odds of that hand winning at the first time or the second time.

In some embodiments, a fifth community card 130 (“river card”) can be dealt at a fourth time, after the third time. In some embodiments, the river card can be the final card dealt. Accordingly, because all hand strengths can be known, the system 100 may not allow players to bet on first hand 110 and/or second hand 120 after the river card is dealt. In such embodiments, after the river card is dealt, system 100 can determine whether first hand 110 and/or second hand 120 is the winner. The winner can be determined based on the relative strength of the first hand 110 to the second hand 120. In some embodiments, first hand 110 and second hand 120 can tie and can result in both first hand 110 and second hand 120 being declared the winning hand. In some embodiments, a tie can result in neither the first hand 110 nor the second hand 120 being declared a winner. In such embodiments, no payouts may be made. In other such embodiments, bets placed on the hands that tie may be returned to a player.

As described above, some poker games may not include community cards. In such embodiments, players can optionally bet at each stage according to the rules of the game. For example, in a stud game, players can optionally bet after each hand is dealt a single card until all hands are dealt a predetermined amount of cards. In one example, using five-card stud rules, bets can be made at four times, after each hand is dealt a first card, a second card, a third card, and a fourth card. In such embodiments, no bets would be allowed after the fifth card is dealt, because the winner would be known. Similarly, in an example using five-card draw rules, additional betting can be allowed after hands are fully dealt, as well as during stages of drawing. In such embodiments, whether a hand draws cards can be determined by the payout module based on a predetermined set of rules.

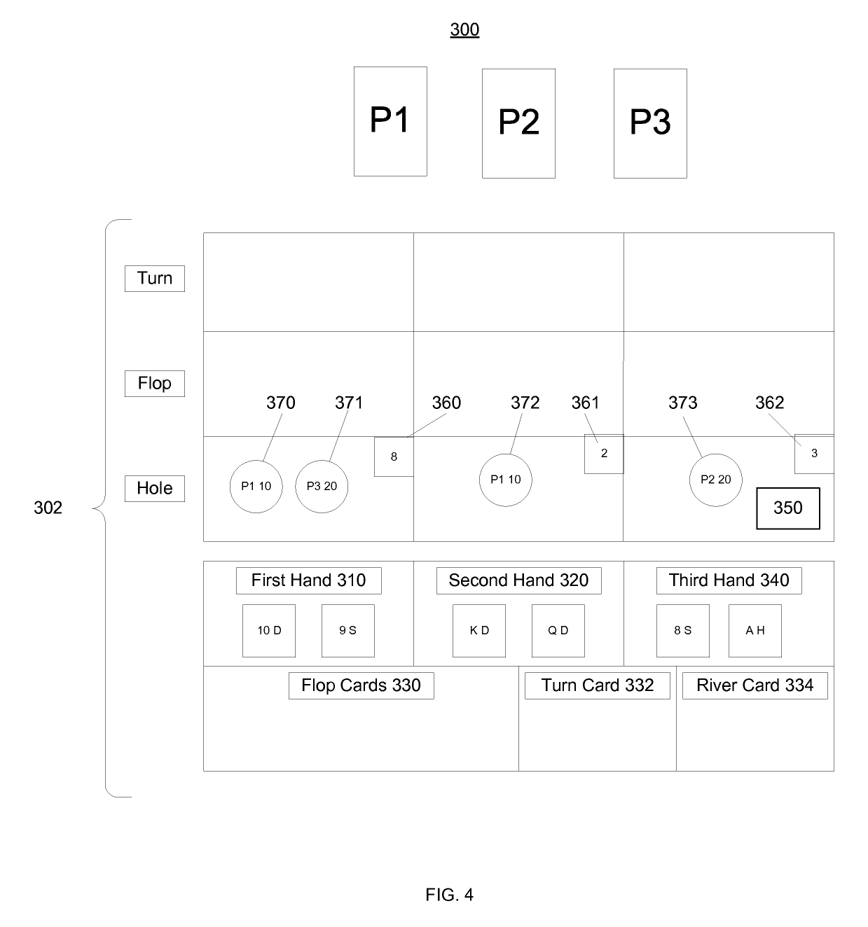

In some embodiments, system 100 can include a display configured to display, or otherwise present a layout for organizing a game played using system 100. In such embodiments, the layout can be, for example, grid-like (see, e.g., FIGS. 4-7). As discussed herein, a display can be a purpose built and/or general poker table.

Payout module 104 can define, a payout for first hand 110 and/or second hand 120 at a given time during a round (e.g., the first time, the second time, etc) based at least on (1) the mathematical odds of that hand winning, (2) a predetermined payout percentage, (3) a house cut, and/or (4) a bet made on a hand at a given time during a round. Payout module 104 can include a processor, memory and/or display, and can store, for example, rules of one or more poker games, predetermined payout percentages, house cut rules, etc. In such embodiments, the processor of payout module can receive value indicative of a bet and/or associated player, and can define a payout and send one or more signals configured to cause a display to display a payout indicator, as described herein. Payout module 104 can calculate various odds related to and/or including the mathematical odds of a hand winning. For example, payout module 104 can calculate the mathematical odds of one or more hands winning based on cards currently dealt. In such embodiments, payout module 104 can reduce a value associated with the mathematical odds based on a house cut to define margin odds. In other embodiments, payout module 104 can round the value associated with the mathematical odds and/or a value associated with the margin odds (before and/or after calculating margin odds) in accordance with display capabilities, game rules, and/or tradition. In such embodiments, rounded margin odds and/or rounded mathematical odds can be referred to as rounded odds.

In other embodiments, payout module 104 can pre-deal all cards, e.g., each hand's hole cards and all community cards, and can calculate odds of each hand winning at each stage of a round. In such embodiments, the pre-dealt cards (hole and community) can meet certain predetermined criteria for that round to be played. In some embodiments, a predetermined criterion can be, for example, when the winning hand is ranked less than two pair, the round is not played and new hands are pre-dealt. In some embodiments, a predetermined criterion can be, for example, when more than one hand is not eligible to win prior to the final stage, the round is not played and new hands are pre-dealt. In some embodiments, a predetermined criterion can be, for example, when the winning hand is above a payout threshold, the round proceeds. Predetermined criteria can include any combinations of factors including, eligibility of any number of hands winning at various stages, strength of one or more hands at various stages, payout thresholds, current jackpot and/or progressive jackpot, etc, and/or combinations of these factors. In other such embodiments, the predetermined criteria can extend over multiple rounds, for example at least one hand in every third round can have above predetermined odds. In this manner, the house can control aspects of the game to ensure favorable returns and/or conformance with advertized payouts/return-to-player rates.

In some embodiments, payout module 104 can maintain and/or monitor statistics related to one or more rounds of a game, for example, over a period of time. In such embodiments, payout module 104 can monitor, for example, a return-to-player statistic per day, e.g., what percentage of player bets are returned to players. In such embodiments, if a return-to-player percentage is below a predetermined threshold, payout module 104 can calculate a progressive jackpot. A progressive jackpot can be, for example, a payout amount that would increase the return-to-player percentage to about the predetermined threshold. Such a progressive jackpot system can also be configured to account for rounded odds as described above.

In some embodiments, payout module 104 can include an odds indicator (not shown) and/or the payout indicator (not shown), that can be displayed and/or otherwise communicated to the one or more players. For example a display can include one or more betting areas (not shown) that can be based on the betting time (for example at the first time, the second time, and/or the third time. The display can include one or more card areas (not shown) that can be configured to display and/or receive first hand 110, second hand 120, and community card 130. The display can be configured to display and/or otherwise indicate a payout, e.g. a payout amount based on odds, e.g. mathematical odds, margin odds, and/or rounded odds, of first hand 110 and second hand 120. In some embodiments the payout and/or odds of winning can change based on community card 130. In such embodiments, previous and/or current odds of winning can be displayed, and can continue to be displayed until the end of a round. In some embodiments, only the current payout and/or odds of winning can be displayed. The display can be configured to indicate whether first hand 110 and/or second hand 120 is the winning hand, as well as the payout to each winning player. In such embodiments, the display can be configured to indicate total winnings and/or portions of winnings based on different bets at different times. In some embodiments, the display can be configured to display mathematical odds, margin odds, and/or rounded odds. In some embodiments, the display can be configured to display game statistics, for example, recent payout, regular or progressive jackpots, bonuses, payout statistics, etc. In some embodiments, portions of payout module 104 can be integral with layout 102. For example, a payout indicator can be integral with the layout (see, e.g., FIG. 4-7).

In some embodiments a player indicator (not shown) and/or a player-bet indicator can be displayed and/or otherwise communicated to the one or more players. A player indicator can communicate a name, likeness, and/or other representation of a player, as well as other information such as available currency, etc. A player-bet indicator can be displayed in a betting area and can indicate a bet an associated player has made on a hand at a predetermined time. Player-bet indicators may only be displayed during the associated time period, for example, a first player bet made on first hand 110 after the first time may not be displayed after the second time. In such embodiments, after a round is over a winning hand(s) is declared; all winning player-bet indicators can be displayed. In some embodiments, all player-bet indicators can be displayed until a round is over. One such embodiment can include a physical playing surface with physical player-bet indicators (e.g. poker chips).

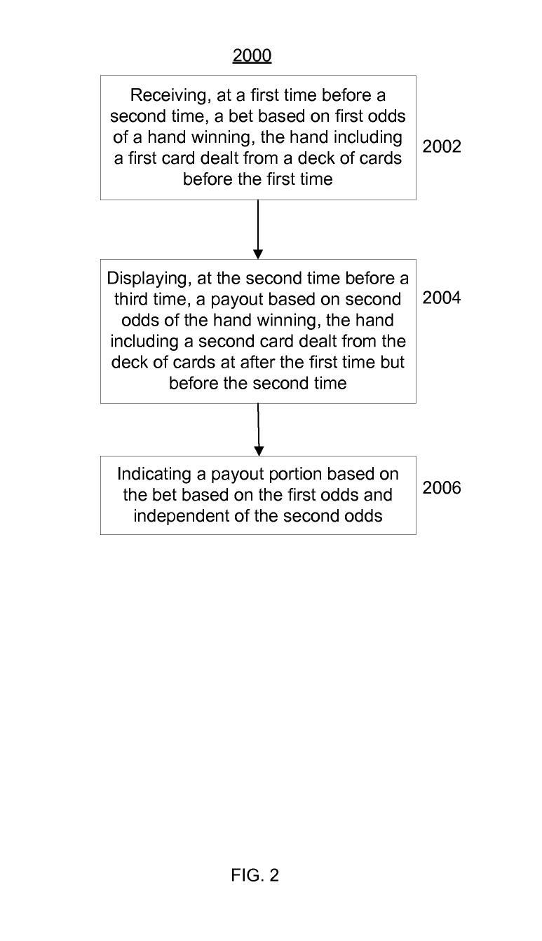

FIG. 2 is a flow chart depicting a method 2000 of operating a poker game system according to an embodiment. Method 2000 includes receiving, at a first time before a second time, a bet based on first odds of a hand winning, the hand including a first card dealt from a deck of cards before the first time, at 2002. Method 2000 includes displaying, at the second time before a third time, a payout based on second odds of the hand winning, the hand including a second card dealt from the deck of cards at after the first time but before the second time, at 2004. Method 2000 includes indicating a payout portion based on the bet based on the first odds and independent of the second odds, at 2006.

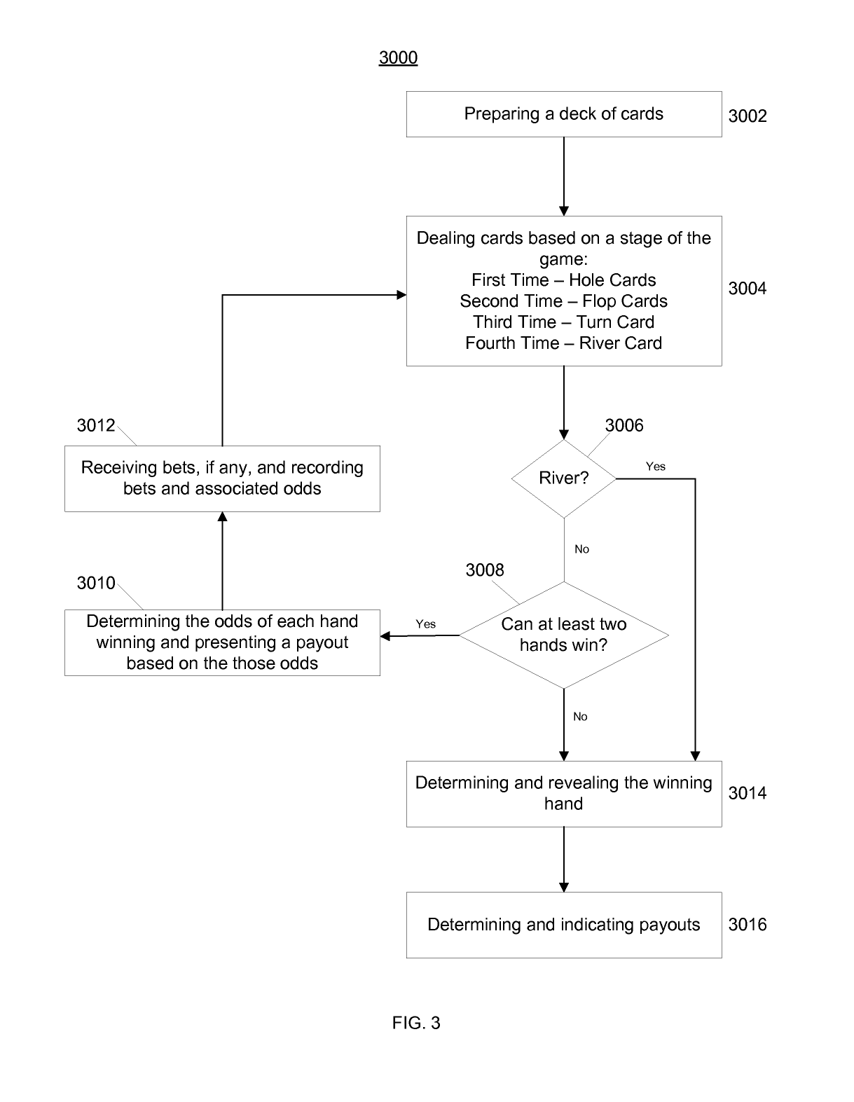

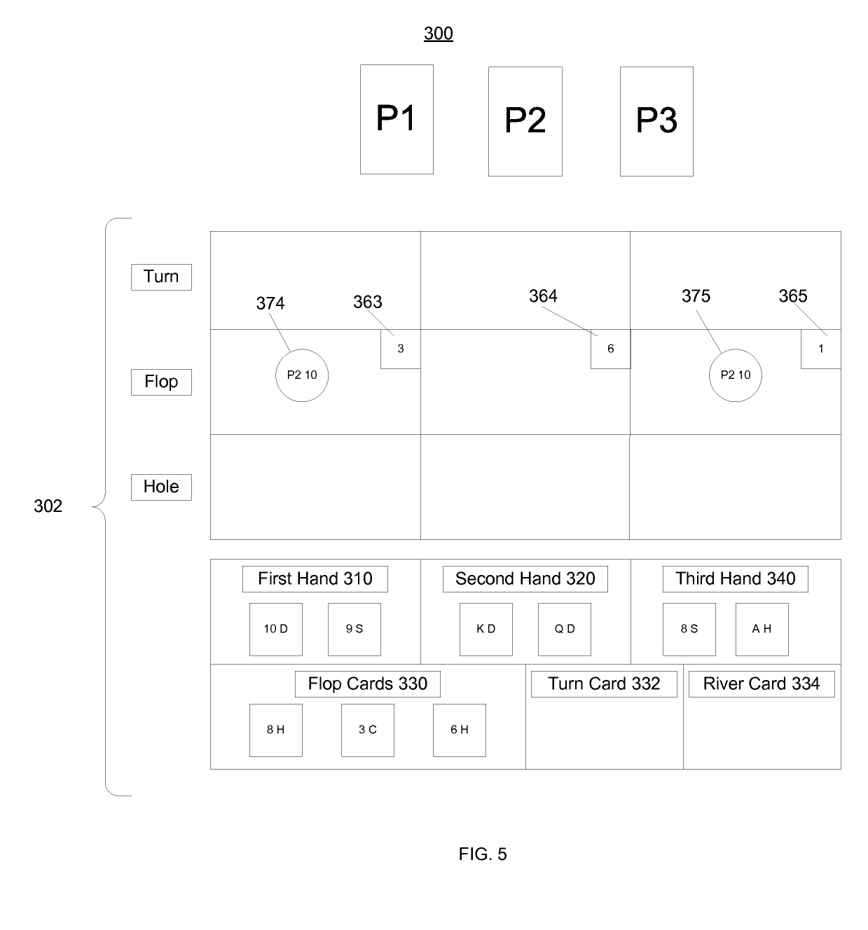

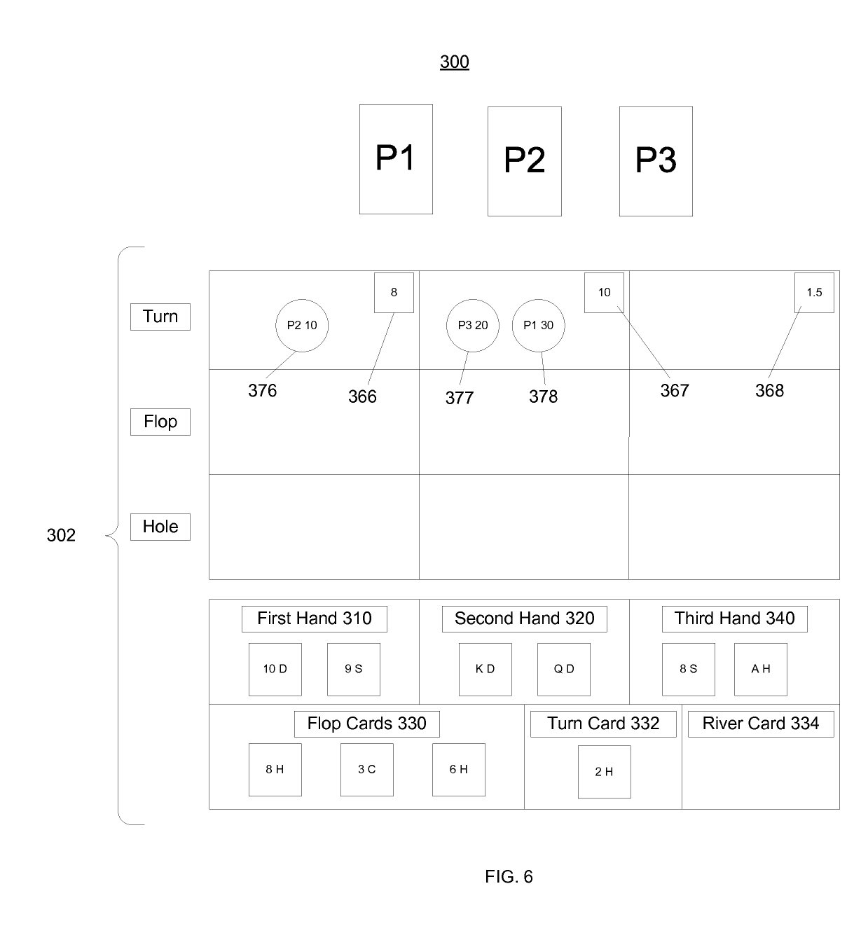

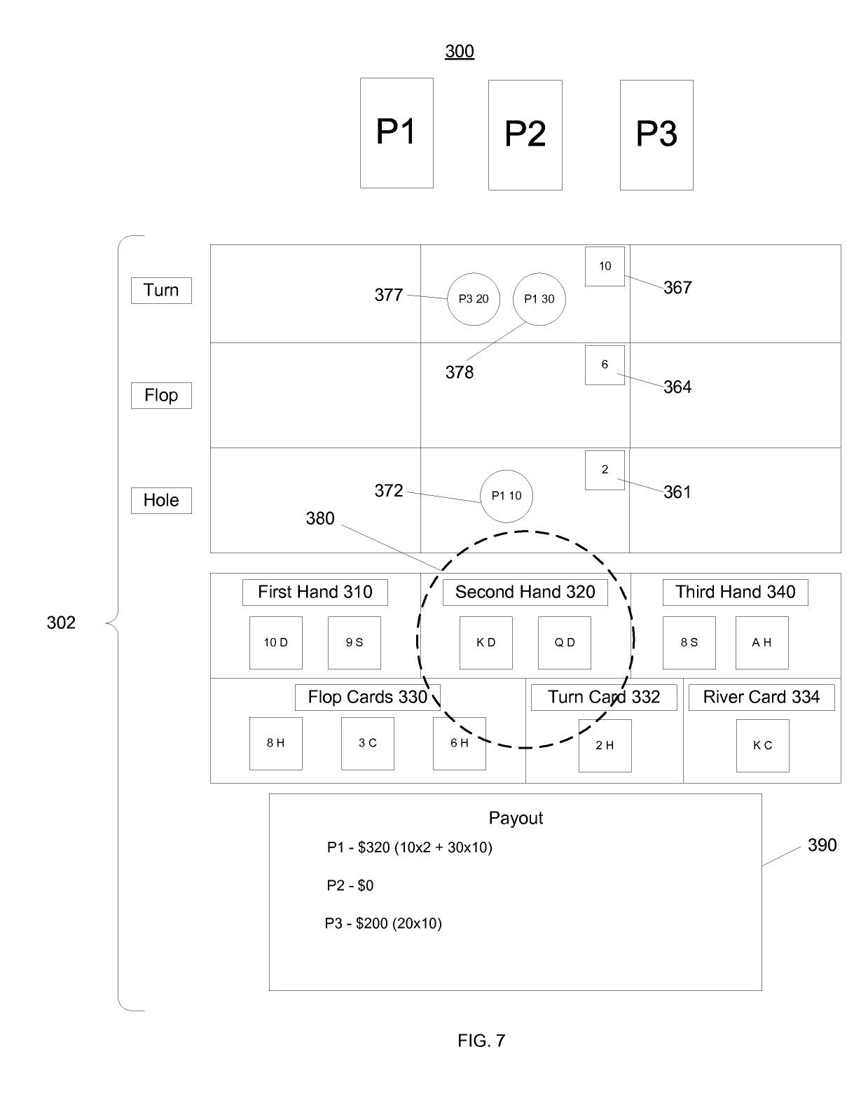

FIG. 3 is a flow chart depicting a method 3000 of operating a poker game system, such as poker game system (“system”) 300. FIGS. 4-7 depict an exemplary embodiment of system 300 at different times during a round. Specifically FIG. 4 depicts system 300 at a first time, FIG. 5 depicts system 300 at a second time after the first time, FIG. 6 depicts system 300 at a third time after the second time, and FIG. 7 depicts system 300 at a fourth time after the third time. System 300 can be similar to system 100 and can include similar components. For example, system 300 can include a first hand 310 similar to first hand 110, and a payout indicator (not shown in FIGS. 4-7) similar to payout module 104.

As shown in FIGS. 4-7, system 300 includes a layout 302, the first hand 310, a second hand 320, a third hand 340, flop cards 330, a turn card 332, and a river card 334. System 300 includes at least one betting area 350, payout indicators 360-368, player-bet indicators 370-378, and player indicators P1, P2 and P3.

Method 3000 includes preparing a deck of cards, at 3002. Method 3000 includes dealing cards based on the stage of the game, at 3004. As shown in FIG. 4, at a first time, first hand 310 (ten of diamonds and nine of spades), second hand 320 (king of diamonds and queen of diamonds) and third hand 340 (eight of spades and ace of hearts) can be dealt. Method 3000 includes determining whether the river card has been dealt, at 3006. As shown in FIG. 4, at the first time, river card 334 has not been dealt. Accordingly, method 3000 can include determining whether at least two hands from first hand 310, second hand 320 and third hand 340 can win, e.g., whether at least two hands still have mathematical odds of winning the round, at 3008. In such embodiments, whether at least two hands still have mathematical odds of winning the round can be determined by the payout module. In the example shown in FIG. 4, because at least two hands can still win, method 3000 includes determining the odds of each hand winning, and presenting payout indicators based on those odds, at 3010. In such an example, the odds of each hand winning and the payout can be determined by the payout module. In some embodiments, if any of first hand 310, second hand 320, and/or third can 340 can no longer win, for example, as determined by the payout module; system 300 can eliminate that hand and prohibit a player from placing a bet on an eliminated hand. As shown in FIG. 4, layout 302 can include a first payout indicator 360 indicating a payout of 8:1 if first hand 310 wins, a second payout indicator 361 indicating a payout of 2:1 if second hand 320 wins, and a third payout indicator 362 indicating a payout of 3:1 if third hand 340 wins. As described herein, payout indicators 360-380 can indicate a payout of a hand based on the mathematical odds of that hand winning a round, a predetermined payout and/or a house cut, as defined by the payout module. Method 3000 includes receiving bets, if any, and recording bets and associated odds, at 3012. In the example shown in FIG. 4, layout 302 includes a first player-bet indicator 370 indicating that a player P1 has placed a bet of $10 on first hand 110, a second player-bet indicator 371 indicating that a player P3 has placed a bet of $20 on first hand 310; a third player-bet indicator 372 indicating that player P1 has placed a bet of $10 on second hand 320, and a fourth player-bet indicator 373 indicating that a player P2 has placed a bet of $20 on the third hand 340.

Method 3000 returns to dealing cards based on the stage of the game, at 3004. As shown in FIG. 5, at a second time, flop cards 330 (eight of hearts, three of clubs and six of hearts) can be dealt. Method 3000 includes determining whether the river card has been dealt, at 3006. As shown in FIG. 5, at the second time, river card 334 has not been dealt. Accordingly, method 3000 can include determining whether at least two hands from first hand 310, second hand 320 and third hand 340 can win, at 3008. In the example shown in FIG. 5, because at least two hands can still win, method 3000 includes determining the odds of each hand winning, and presenting payout indicators based on those odds, at 3010. As shown in FIG. 5, layout 302 can include a fourth payout indicator 363 indicating a payout of 3:1 if first hand 310 wins, a fifth payout indicator 364 indicating a payout of 6:1 if second hand 320 wins, and a sixth payout indicator 365 indicating a payout of 1:1 if third hand 340 wins. Method 3000 includes receiving bets, if any, and recording bets and associated odds, at 3012. In the example shown in FIG. 5, layout 302 includes a fifth player-bet indicator 374 indicating that a player P2 has placed a bet of $10 on first hand 110, and a sixth player-bet indicator 375 indicating that player P2 has placed a bet of $10 on third hand 340.

Method 3000 returns to dealing cards based on the stage of the game, at 3004. As shown in FIG. 6, at a third time, turn card 350 (two of hearts) can be dealt. Method 3000 includes determining whether the river card has been dealt, at 3006. As shown in FIG. 6, at the third time, river card 334 has not been dealt. Accordingly, method 3000 can include determining whether at least two hands from first hand 310, second hand 320 and third hand 340 can win, at 3008. In the example shown in FIG. 6, because at least two hands can still win, method 3000 includes determining the odds of each hand winning, and presenting payout indicators based on those odds, at 3010. As shown in FIG. 6, layout 302 can include a seventh payout indicator 366 indicating a payout of 8:1 if first hand 310 wins, an eighth payout indicator 367 indicating a payout of 10:1 if second hand 320 wins, and a ninth payout indicator 368 indicating a payout of 1.5:1 if third hand 340 wins. Method 3000 includes receiving bets, if any, and recording bets and associated odds, at 3012. In the example shown in FIG. 6, layout 302 includes a seventh player-bet indicator 376 indicating that a player P2 has placed a bet of $10 on first hand 110, an eighth player-bet indicator 377 indicating that player P3 has placed a bet of $20 on second hand 340, and a ninth player-bet indicator 378 indicating that player P1 has placed a bet of $30 on second hand 340.

Method 3000 returns to dealing cards based on the stage of the game, at 3004. As shown in FIG. 7, at a fourth time, river card 360 (king of clubs) can be dealt. Method 3000 includes determining whether the river card has been dealt, at 3006. As shown in FIG. 7, at the fourth time, river card 334 has been dealt. Accordingly, method 3000 can include determining and revealing the winning hand(s), at 3014. In some embodiments, before the river card is dealt, if system 300 determined that only one winning hand remains, system 300 can end the round and method 3000 can advance to 3014. As shown in FIG. 7, second hand 320 is indicated to be the winning hand by a winning hand indicator 380. While shown in FIG. 7 as including a visual winning indicator, in some embodiments, a winning hand indicator can be audio, verbal, visual, and/or combinations of audio, verbal and/or visual. As shown in FIG. 7, after the winning hand has been determined, system 300 can display previous player-bet indicators and/or previous payout indicators. In this example, system 300 can display third player-bet indicator 372, eighth player-bet indicator 377, and ninth player-bet indicator 378, second payout indicator 361, fifth payout indicator 364, and eighth payout indicator 367. As shown in FIG. 7, system 300 can display a payout indicator independent of whether a bet was placed at that payout, such as, for example, system 300 can display fifth payout indicator 364 independent of whether player P1, player P2, and/or player P3 made a bet at the second time on second hand 320.

Method 3000 includes determining and indicating payouts, at 3016. As shown in FIG. 7, layout 302 includes a payout indicator 390 indicating that player P1 won $320, player P2 won $0 and player P3 won $200. As shown in FIG. 7, payout indicator 390 can include each portion of a payout. In such embodiments, each portion of a payout can be presented as one or more values indicative of the portion of the payout, for example, a final value, a formula representative of the final value, or both. As shown in FIGS. 4-7, unlike traditional poker games, more than one player can win using a common hand. Also unlike traditional poker games, one or more players payout(s) can be based multiple odds and/or payout values, for the same hand, but at different times.

While FIGS. 4-7 depict system 300 having layout 302, in other embodiments a layout of a poker game system can have more or fewer components depending on, for example, the number of players, the numbers of hands, and/or the rules of the game. For example, a poker game system can include a variable number of hands, more or fewer community cards, more or fewer community cards dealt at different times, more or fewer hole cards, etc. Furthermore, while layout 302 includes a betting row for each stage of the round (e.g., a hole row, a flop row, and a turn row) in some embodiments, such as, for example, electronic embodiments, layout 302 can include a single betting row for each round with player betting indicators made during previous stages removed between stages.

In some embodiments, a payout can include both the portions of the payout and also winning bets. Said another way, and with reference to FIG. 7, player P1 can receive a payout of $360 including first portion of the payout $20, second portion of the payout $300, first bet $10, and second bet $30. In some embodiments, a payout, or portion of a payout, of the one or more players can be reduced by a house cut, or other minimum charge. In some embodiments, a payout amount can be based on the mathematical odds of a hand winning adjusted by a method to normalize payout percentages and/or to provide a house cut. Said another way, and electronic poker game system as described herein can be configured to pay out 90% of bets over a defined number of rounds. For example, a system can be configured to pay out $90 for every $100 bet, on average, over 1000 rounds. In other embodiments, the payout can be configured over more or fewer rounds, over any time period, etc.

As discussed above, while the poker game systems described herein include display and/or other indicator elements typically associated with electronic presentations, any poker game system described herein can include traditional physical components, such as, for example, table, physical poker chips, physical deck of cards, etc. In such embodiments, a poker game system can include bet reader to track a bet(s) of a player(s) at the different stages of a round. Such a bet reader can collect, count and/or sort one or more chips. In such embodiments, bet reader can include a collection module, a counter module, and a sorter module. In some embodiments, a bet reader can be configured to use passive and/or active wireless technology to track chips and/or other bets, for example, radio frequency identification technology. In some embodiments, a poker game system can include a card reader to track cards (hole and community) at the different stages of a round. Such embodiments can use passive and/or active wireless technology and/or optical technology, including bar code readers and/or optical recognition.

In some embodiments, a poker game system can include a fraud detector and/or invalid bet detector (“detectors”). Such detectors can detect new bets placed, or prior bets shifted, after a predetermined time, for example after cards have been dealt for the next stage of a round. Such detectors can determine whether an invalid bet is made, for example exceeds a maximum bet or does not exceed a minimum bet. In some embodiments, the fraud detector and/or the invalid bet detector can use data and/or other information provided by the bet reader and/or card reader.

In some embodiments, a poker game system can include a dispenser module configured to deliver a payout to a dealer or player. In such embodiments, the dispenser module can receive an indication from a payout module indicative of an amount of a payout. In such embodiments, dispenser module can dispense a payout from chip and/or other currency storage module. In some such embodiments, the sorter module can be included in the currency storage module. In some embodiments, a poker game system can include a dead hand indicator, for example, a visual (physical and/or luminous), audio, and/or other indicator to indicate that a hand can no longer win a round. In some embodiments, a poker game system can include a winning indicator, for example, a visual (physical and/or luminous), audio, and/or other indicator to indicate that a hand, or hands, won a round. Furthermore, the poker game systems described herein can be hybrid physical/electronic systems. For example, a poker game system can include a dealer using physical cards, but taking electronic bets, etc.

In some embodiments, system 300 could be configured to have a number of hands equal to a number of players. In other embodiments, the number of hands can be unrelated to the number of players and accordingly can be more, or fewer than the number of players. In some embodiments, system 300 can include a minimum numbers of live players and/or total players, including combinations of live and/or computer players. For example, system 300 can include a minimum of 1 live player and a minimum of one player total.

Some embodiments described herein relate to a computer storage product with a computer-readable medium (also can be referred to as a processor-readable medium) having instructions or computer code thereon for performing various computer-implemented operations. The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), and Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

While various embodiments have been described above, it should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described.

Any portion of the apparatus and/or methods described herein may be combined in any combination, except mutually exclusive combinations. The embodiments described herein can include various combinations and/or sub-combinations of the functions, components and/or features of the different embodiments described. Furthermore, any odds disclosed herein are exemplary only.

What is claimed is:

1. A method, comprising:
receiving, at a first time before a second time, an indication of a bet, the bet associated with first odds of a hand winning, the hand at the first time including a first card that was dealt from a deck of cards before the first time;
displaying, at the second time before a third time, a payout based on second odds of the hand winning, the hand at the second time including a second card that was dealt from the deck of cards after the first time but before the second time; and
displaying, at a third time after the second time, a player payout portion (1) based on the bet, (2) based on the first odds of the hand winning, and (3) independent of the second odds of the hand winning.

2. The method of claim 1, wherein the bet is a first bet, the method further comprising:
receiving, at a fourth time before the third time, an indication of a second bet, the second bet associated with the second odds of the hand winning, the hand at the fourth time including the first card and the second card.

3. The method of claim 1, wherein the bet is a first bet and the hand is a first hand, the method further comprising receiving, before the second time, an indication of a second bet, the second bet based on odds of the second hand winning, the second hand after the first time and before the second time having including a third card that was dealt from the deck of cards before the first time.

4. The method of claim 3, wherein the odds of the second hand winning are first odds of the second hand winning, the method further comprising displaying, at the second time, a payout based on second odds of the second hand winning.

5. The method of claim 1, wherein the player-payout portion is a first player-payout portion and the bet is a first bet, the method further comprising:
displaying, at a fourth time, a payout based on third odds of the hand winning, the hand at the fourth time including a third card that was dealt from the deck of cards after the second time but before the fourth time; and
displaying, at the third time after the fourth time, a second player-payout portion (1) based on a second bet, (2) based on the third odds of the hand winning (3) independent of the second odds of the hand winning and (4) independent of the first odds of the hand winning.

6. The method of claim 1, wherein:
the bet is a first best; and
the player-payout portion is (1) based on the first bet and the first odds of the hand winning, (2) based on a second bet and third odds of the hand winning, and (3) independent of the second odds of the hand winning.

7. The method of claim 1, wherein displaying the payout includes displaying a ratio.

8. A method, comprising
receiving, at a first time before a second time, an indication of a first bet, the first bet associated with a first player and first odds of a hand winning, the hand at the first time including a first card that was dealt from a deck of cards before the first time;
receiving, at the second time before a third time, an indication of a second bet, the second bet associated with a second player and second odds of the hand winning, the hand at the second time including a second card that was dealt from the deck of cards after the first time but before the second time;
indicating, at the third time, (1) a player-payout portion associated with the first player and based on the first bet, based on the first odds of the hand winning, and independent of the second odds of the hand winning, and (2) a player-payout portion associated with the second player and based on the second bet, based on the second odds of the hand winning, and independent of the first odds of the hand winning.

9. The method of claim 8, wherein the player-payout portion associated with the first player is a first player-payout portion associated with the first player, the method further comprising:
receiving, at a fourth time before a third time, an indication of a third bet, the third bet associated with the first player and the second odds of the hand winning; and
indicating, at the third time, a second player-payout portion associated with the first player and based on the third bet, based on the second odds of the hand winning, and independent of the first odds of the hand winning.

10. The method of claim 8, wherein the hand is a first hand, the method further comprising:
receiving, before the second time, an indication of a third bet, the third bet associated with the first player and odds of a second hand winning, the second hand including a third card that was dealt from the deck of cards before the first time.

11. The method of claim 8, wherein indicating the player-payout portion associated with the first player includes sending a signal configured to cause a display to output a visual indicator indicative of the player-payout portion associated with the first player.

12. The method of claim 8, further comprising:
sending, at a fourth time before the second time, a signal configured to cause a display to output a first visual indicator indicative of the first bet; and
sending, after the fourth time and before the third time, a signal configured to cause the display to not output the first visual indicator.

13. The method of claim 8, wherein, at the first time, the hand only includes (1) the first card, (2) a third card that was dealt from a deck of cards before the first time, and (3) a fourth card that was dealt from a deck of cards before the first time.

14. The method of claim 8, wherein the first odds of the hand winning is based on mathematical odds of the hand winning at the first time and a house payout.

15. A method, comprising
receiving, at a first time before a second time, an indication of a first bet, the first bet associated with a player and first odds of a hand winning, the hand at the first time including a first card that was dealt from a deck of cards before the first time;
receiving, at the second time before a third time, an indication of a second bet, the second bet associated with the player and second odds of the hand winning, the hand at the second time including a second card that was dealt from the deck of cards after the first time but before the second time;
indicating a player-payout including (1) a first player-payout portion based on the first bet, based on the first odds of the hand winning, and independent of the second odds of the hand winning, and (2) a second player-payout portion based on the second bet, based on the second odds of the hand winning, and independent of the first odds of the hand winning.

16. The method of claim 15, wherein the player is a first player, the method further comprising receiving, at the second time, an indication of a third bet, the third bet associated with a second player and the second odds of the hand winning.

17. The method of claim 16, wherein the player-payout is a first player-payout, the method further comprising indicating a second player-payout including a player-payout portion based on the third bet, based on the second odds of the hand winning, and independent of the first odds of the hand winning.

18. The method of claim 15, wherein the hand is a first hand, the method further comprising receiving, at a third time before the second time, an indication of a third bet, the third bet associated with the player and odds of a second hand winning, the second hand at the third time including a third card that was dealt from a deck of cards before the first time.

19. The method of claim 15, wherein indicating the player-payout includes sending a signal configured to cause a display to output a visual indicator indicative of the player-payout.

20. The method of claim 15, wherein the first odds of the hand winning is based on rounded odds of the hand winning at the first time.
